(19) United States
(12) Patent Application Publication
(10) Pub. No.: US 2013/0334140 A1
(43) Pub. Date: Dec. 19, 2013

(54) TREATMENT OF EFFLUENTS FROM THE ELECTROPLATING INDUSTRY

(71) Applicants: Wolfgang Podesta, Leverkusen (DE); Stephan Neumann, Leverkusen (DE)

(72) Inventors: Wolfgang Podesta, Leverkusen (DE); Stephan Neumann, Leverkusen (DE)

(73) Assignee: LANXESS DEUTSCHLAND GMBH, LEVERKUSEN (DE)

(21) Appl. No.: 13/823,942

(22) PCT Filed: Sep. 15, 2011
(86) PCT No.: PCT/EP11/65978

§ 371 Date: Sep. 5, 2013

(30) Foreign Application Priority Data
Sep. 16, 2010 (EP) 10009700.5

(51) Int. Cl. C02F 1/42

(52) U.S. Cl. CPC C02F 1/42
USPC 210/683

(57) ABSTRACT

The invention relates to a process for separating fluorinated acids, in particular perfluorocarboxylic acids and perfluorosulphonic acids, or salts thereof from metal-containing, aqueous solutions, in particular those which occur in the electroplating industry, by means of anion exchangers.

The invention relates to a process for separating fluorinated acids, in particular perfluorocarboxylic acids and perfluorosulphonic acids, or salts thereof from metal-containing, aqueous solutions, in particular those which occur in the electroplating industry, by means of anion exchangers.

Fluorinated acids and salts thereof, in particular perfluorosulphonic acids (PFOS) and their alkaline metal and ammonium salts, are frequently used as wetting agents or spray mist suppressors in the electroplating industry, for example in hard chromium plating and decorative chromium plating.

The main advantages here are the high stability of the fluorinated acids, the uniform wetting of the parts to be chromium plated and the avoidance of toxic chromium(VI) discharges from the chromium sulphuric acid or chromium plating baths used and the associated hazards to human beings and the environment.

However, the persistence and the poor biodegradability and also the associated accumulation in the food chain are disadvantages. For this reason, efforts are being made in many countries to place legal restrictions on discharges into the environment, in the European Union for example by means of the EU Directive 2006/122/EC.

For this reason, there has been an intensive search, particularly in recent years, for a method of removing fluorinated acids as quantitatively as possible from wastewater from electroplating operations.

Here, various approaches such as absorption on activated carbon or precipitated calcium fluoride, separation by evaporation of water and liquid-liquid extraction have been employed.

DE 199 53 285 A describes the use of anion exchangers for removing wastewater containing perfluorooctanoic acid from the preparation of fluoropolymers, where the perfluorooctanoic acid absorbed on the resin can be eluted by means of ammonia-containing, water-soluble organic solvents having a boiling point of <150° C.

DE-A 2 044 986 discloses a process for isolating perfluorocarboxylic acids from dilute aqueous solutions, where the latter are brought into contact with a weakly basic anion exchange resin and the perfluorocarboxylic acid absorbed thereon is eluted by means of an aqueous ammonia solution.

U.S. Pat. No. 5,442,097 discloses a process for recovering fluorinated carboxylic acids from emulsion polymers. The fluorine-containing carboxylic acids used here as surfactants are converted by means of a suitable alcohol into the corresponding ester and the latter is separated off by distillation.

JP 2010158662 describes a process for removing fluorinated surfactants such as perfluorooctanoic acid from aqueous solutions by means of activated carbon filters, which according to JP 2010029763 is modified additionally by a treatment of the wastewater with nanobubbles, leading at least partly to destruction of the persistent perfluoro compounds, before the activated carbon filter.

Finally, WO 2008/101137 describes a process for removing fluorine chemicals including perfluorooctanesulphonates or perfluorooctanecarboxylates from ground and surface water by means of ion exchangers. Here, the concentration of the fluorine chemicals can be in the ppm to ppb range.

EP 1314700A1, EP 1193242 A and EP 014431 A discloses the removal of perfluorooctanesulphonates or fluorinated alkanoic acids from production wastewater from the preparation of polytetrafluoroethylene (PTFE) by means of ion exchangers. However, the wastewater is not metal-containing in the sense of the present invention.

WO 2008/066748 A1 discloses the removal of fluorinated hydrocarbons from ground water by means of ion exchangers. However, the ground water is likewise not metal-containing in the sense of the present invention.

Deng Shubo et al., Water Research, Vol. 44, No. 18, pp. 5188 to 5195, too, discloses the batchwise removal of perfluorooctanesulphonates from chromium-containing electroplating wastewater, but the required high adsorption of relevant contents of chromium compounds and perfluorinated acids which typically occur in practice is not addressed. All these processes have unsatisfactory selectivity of the agents used for the fluorinated acids to be separated off or require large amounts of process chemicals such as ammonia, alcohols or other organic solvents to regenerate the free acids or distil the esters. The enrichment effect initially achieved is thus predominantly negated again.

In addition, some of the processes were developed only for the removal of fluorinated carboxylic acids, and application to the corresponding sulphonic acids is not readily possible because of the different physicochemical properties.

Furthermore, the sometimes very high content of accompanying constituents such as sulphuric acid, chromic acid and various metal ions has to be taken into account in the case of treatment of wastewater from electrolytic chromium plating plants.

In addition, the relatively short-chain compounds such as perfluorobutanesulphonic acid or salts thereof which are likewise present in the perfluorooctanesulphonic acids used as a result of the method of manufacture can typically be separated off from the aqueous phase to only a significantly reduced extent because of the decreased binding to the agents used, which is particularly true in the case of activated carbon filters.

It was therefore an object of the invention to provide a process which allows very complete removal of fluorinated acids from metal-containing, aqueous solutions.

We have now found a process for separating fluorinated acids or salts thereof from their metal-containing, aqueous solutions, which is characterized in that abovementioned solutions are contacted with at least one weakly or strongly basic anion exchanger.

The scope of the invention encompasses the definitions of radicals or parameters indicated above and below, in general terms or in preferred ranges, in any combination with one another.

For the purposes of the invention, the term “aqueous solution” refers to a liquid medium which has a solids content of less than 5% by weight, preferably less than 1% by weight and particularly preferably less than 0.05% by weight, and contains at least 80% by weight, preferably at least 90% by weight, of water and at least one fluorinated acid or at least one salt of a fluorinated acid, where the total amount of fluorinated acid or salts of fluorinated acids is from 1 to 200 000 μg/l, preferably from 1 to 100 000 particularly preferably from 10 to 2000 μg/l, very particularly preferably from 10 to 1000 μg/l and even more preferably from 10 to 500 μg/l.

For the purposes of the invention, fluorinated acids are acids which have from 1 to 10 carbon atoms and at least one fluorine atom and have a pKa under standard conditions of 6.0 or less. Here, one or more acid groups, preferably one acid group, can be present, where in the case of polybasic acids the pKa indicated relates in each case to the first deprotonation step.

Fluorinated acids which are preferred for the purposes of the invention are polyfluorocarboxylic and perfluorocarboxylic acids of the formula (I) and polyfluorosulphonic and perfluorosulphonic acids of the formula (II)

F—(CF₂)ₙ—(CH₂)ₘ—COOH (I)

F—(CF₂)ₙ—(CH₂)ₘ—SO₂OH (II)

where in each case
n is an integer from 3 to 10, preferably from 4 to 8, and
m is 0 or an integer from 1 to 4.

Very particularly preferred fluorinated acids are perfluorooctanesulphonic acid, perfluorooctanecarboxylic acid, perfluorobutanesulphonic acid and perfluorobutanecarboxylic acid.

The definitions of ranges and preferred ranges mentioned above for the fluorinated acids apply completely analogously to the corresponding salts of fluorinated acids. For the purposes of the present invention, a salt of a fluorinated acid is a compound in which the acid proton has been replaced by another cation, for example a metal cation or ammonium ion such as an organic primary, secondary, tertiary or quaternary ammonium ion, for example a tetraethylammonium ion.

For the purposes of the present invention, metal-containing means a content of at least one transition metal compound, where the content of transition metal compounds calculated as the respective transition metal oxide having the same oxidation state as the at least one transition metal compound present is from 10 mg/l to 100 g/l, preferably from 50 mg/l to 10 g/l, particularly preferably from 100 mg/l to 5 g/l, very particularly preferably from 250 mg/l to 5 g/l and even more preferably from 500 mg/l to 5 g/l.

Preference is given to the dilute, metal-containing aqueous solutions being chromium-containing and having a chromium content of from 10 mg/l to 100 g/l, preferably from 50 mg/l to 10 g/l, particularly preferably from 100 mg/l to 5 g/l, very particularly preferably from 250 mg/l to 5 g/l and even more preferably from 500 mg/l to 5 g/l, calculated as chromium(VI) oxide, with the chromium being present in the form of chromic acid or chromates and/or alternatively in the form of dichromic acid or dichromates.

The chromium-containing solutions can additionally be copper-, iron- or nickel-containing.

In an illustrative embodiment, the pH of the metal-containing, aqueous solutions of fluorinated acids or salts thereof is from 0 to 7 under standard conditions, preferably from 0.0 to 5.5 and particularly preferably from 1.0 to 5.5.

In another embodiment, the pH is from 0.0 to 3.0, preferably from 1.0 to 3.0, very particularly preferably from 1.0 to 2.5, under standard conditions.

In another embodiment, the pH is from 0.0 to 2.5, preferably from 0.0 to 2.0, under standard conditions.

If the dilute, metal-containing aqueous solutions have a pH of less than 7 under standard conditions, they preferably contain sulphuric acid and/or hydrogensulphate.

The metal-containing, aqueous solutions used according to the invention are preferably wastewater from electroplating plants, in particular wastewater from hard chromium plating or decorative chromium plating, including the wastewater from the pickling baths which typically precede the electroplating plants and also the wastewater from the rinsing cascades and wastewater obtained from offgas scrubbers of electroplating plants.

The wastewater can, for example, be either collected directly after the electroplating or chromium plating process and fed to the process of the invention or else after reduction of the transition metal compounds still present, in particular chromium(VI) compounds, and optionally after removal of precipitates, for example by means of chamber filter presses.

Suitable anion exchangers encompass strongly basic and weakly basic anion exchangers, where strongly basic anion exchangers are, in particular, anion exchangers which contain quaternary ammonium ions and weakly basic anion exchangers are ion exchangers which contain primary, secondary or tertiary amine groups or their corresponding ammonium ions as structural elements.

Preferred strongly basic anion exchangers are anion exchangers which have the structural element of the formula (III)

—N⁺(R¹R²R³)X⁻ (III)

where
R¹, R² and R³ are each, independently of one another, C₁-C₁₂-alkyl which may either be unsubstituted or further monosubstituted or polysubstituted by hydroxy or C₁ -C₄-alkoxy, or two of the radicals together form C₂-C₁₂-alkylene which may be monosubstituted or polysubstituted by hydroxy or C₁-C₄-alkoxy and
X⁻ is an anion which, in a preferred embodiment, is selected from the group consisting of fluoride, chloride, bromide, hydroxide, nitrate, hydrogen sulphate, and sulphate.

Preferred weakly basic anion exchangers are anion exchangers which have the structural element of the formula (IV) or the structural element of the formula (V) or have structural elements of the formulae (IV) and (V)

−N⁺(R⁴R⁵R⁶)X⁻ (IV)

where
R⁴, R⁵ and R⁶ are each, independently of one another, hydrogen or C₁-C₁₂-alkyl which may be either unsubstituted or further monosubstituted or polysubstituted by hydroxy or C₁-C₄-alkoxy, or, if two of the radicals R⁴, R⁵ and R⁶ are not hydrogen, these radicals together form C₂-C₁₂-alkylene which may be monosubstituted or polysubstituted by hydroxy or C₁-C₄-alkoxy, but at least one, preferably one or two, particularly preferably one, of the radicals R⁴, R⁵ and R⁶ is hydrogen, and
X⁻ is an anion which in a preferred embodiment is selected from the group consisting of fluoride, chloride, bromide, hydroxide, nitrate, hydrogensulphate and sulphate, preferably hydrogensulphate and sulphate,

−N(R⁷R⁸) (V)

where
R⁷ and R⁸ are each, independently of one another, hydrogen or C₁-C₁₂-alkyl which may either be unsubstituted or further monosubstituted or polysubstituted by hydroxy or C₁-C₄alkoxy, or, if two of the radicals R⁷ and R⁸ are not hydrogen, these radicals together form C₂-C₁₂-alkylene which may be monosubstituted or polysubstituted by hydroxy or C₁-C₄-alkoxy.

In principle, suitable ion exchangers also encompass those which have the structural elements of the formulae (III) and also (IV) and/or (V).

According to the invention, the dilute, metal-containing aqueous solutions are contacted with at least one weakly or strongly basic anion exchanger.

This includes both contacting with a plurality of weakly basic or a plurality of strongly basic anion exchangers and also contacting with at least one weakly basic and at least one strongly basic anion exchanger.

As weakly basic ion exchangers, preference is given to those which have the structural element of the formulae (IV) and/or (V).

Particularly preferred anion exchangers are Lewatit® MP 62, a weakly basic, macroporous anion exchanger having tertiary amino groups, Lewatit® MP 64, a weakly basic, macroporous anion exchanger based on a styrene-divinylbenzene copolymer, Lewatit® Monoplus MP 500, a strongly basic, macroporous anion exchanger, and Lewatit 200 Monoplus MP 600, a strongly basic, macroporous anion exchanger, all from Lanxess Deutschland GmbH.

Further suitable anion exchangers which may be mentioned are the commercially available anion exchangers Amberlite® or Duolite® from Dow Chemical.

The anion exchanger is preferably present at least partly in the sulphate or hydrogensulphate form, i.e. sulphate or hydrogensulphate anions are bound via ionic interactions to the anion exchangers.

This is typically achieved by the anion exchanger being brought into contact with dilute, aqueous sulphuric acid which typically has a concentration of from 0.1 to 20% by weight, calculated as H₂SO₄.

The contacting of the metal-containing aqueous solutions of fluorinated acids or salts thereof with the anion exchanger can be carried out in a manner known per se, for example by the ion exchangers being installed in conventional apparatuses such as tubes or columns through which the dilute, metal-containing aqueous solutions flow.

The contacting of the metal-containing aqueous solutions of fluorinated acids or salts thereof with the anion exchanger is carried out, for example, at a flow rate of from 0.5 to 200, preferably from 2 to 100, parts by volume of metal-containing aqueous solution per hour and part by volume of anion exchanger.

The wastewater remaining after contacting of the metal-containing, aqueous solutions of fluorinated acids or salts thereof with the anion exchanger typically has a significantly lower content of fluorinated acids or salts thereof than before contacting, with the process preferably being controlled so that at least 90% by weight of the fluorinated acids or salts thereof present in the dilute aqueous solutions used is bound by the anion exchanger, preferably 95% by weight.

This is ensured, for example, when the anion exchanger is regenerated or replaced after passage of or contacting with a particular amount of dilute, metal-containing aqueous solution.

The capacity of the anion exchanger for fluorinated acids or salts thereof depends, inter alia, on the type of anion exchanger selected and the type and content of fluorinated acids or salts thereof and also further anions, for example chromates in the case of wastewater from chromium plating, in the dilute, metal-containing aqueous solutions used. However, these can be determined in a manner known per se in simple preliminary experiments by a person skilled in the art.

The wastewater can optionally be brought into contact with conventional adsorbents such as activated carbon in order to remove any residues of fluorinated acids or salts thereof.

It is also possible for wastewater which has firstly been brought into contact with conventional absorbents such as activated carbon in order to reduce the content of fluorinated acids or other impurities subsequently to be brought to an even lower content of fluorinated acids by means of anion exchangers.

This variant is particularly useful when an activated carbon filter is already present but the desired content of fluorinated acids cannot be achieved. This is particularly true in the case of wastewater containing relatively short-chain perfluorosulphonic acids or perfluorocarboxylic acids in addition to perfluorooctanesulphonic acid or perfluorooctanecarboxylic acid, since these are typically absorbed to a lesser degree on activated carbon.

The fluorinated acids or anions thereof which are bound via ionic bonds to the anion exchangers can generally be eluted only with difficulty because of the strong interaction with the anion exchanger in aqueous medium, for example dilute sodium hydroxide solution.

Preference is therefore given to incinerating the anion exchangers loaded with fluorinated acids at temperatures above 1100° C. This ensures that the fluorinated acids are quantitatively eliminated and the environment is thus protected against possible exposure.

The advantage of the invention is the superior separation of fluorinated acids or salts thereof from dilute, metal-containing aqueous solutions compared to the prior art.

### EXAMPLES

### Examples 1 to 4

500 ml of a strongly acidic rinsing water having a pH of 1.5 from decorative chromium plating, which still contained 0.75 g/l of chromate calculated as CrO₃ and about 0.5 mg/l of fluorinated acids, were pumped at a rate of 1 l/h through 100 ml of the material indicated in Table 1 in a chromatography column. The filtrate was subsequently homogenized and analysed for fluorinated acids. Table 1 shows the results.

TABLE 1
Adsorption on various media

| | | Material | | | |
|---|---|---|---|---|---|
| | | PFBA | PFBS | PFOA | PFOS |
| Example | Sample | [μg/l] | [μg/l] | [μg/l] | [μg/l] |
| | Starting sample | <3 | 64 | <3 | 411 |
| 1 (for comparison) | OC1064 | 1.4 | 7.6 | <0.3 | 44 |
| 2 (for comparison) | Lewatit ®AF5 | 1.5 | 7.8 | <0.3 | 44 |
| 3 | Lewatit ® MP62 | 1.4 | <0.3 | <0.3 | <0.3 |
| 4 | Lewatit ®MP500 | 0.8 | <0.3 | <0.3 | <0.3 |

PFBA = perfluorobutanecarboxylic acid
PFBS = perfluorobutanesulphonic acid
PFOA = perfluorooctanecarboxylic acid
PFOS = perfluorooctanesulphonic acid
OC1064 = adsorber resin
Lewatit ®AF5 = activated carbon
Lewatit ®MP62 = weakly basic anion exchanger (Lanxess Deutschland GmbH)
Lewatit ® Monoplus M500 = strongly basic anion exchanger (Lanxess Deutschland GmbH)

It can be seen from the table that the initial concentration of fluorinated acids is particularly strongly reduced in the eluate, especially in the case of the anion exchangers.

In contrast to the use of the adsorber resin OC 1064, not only the main component (PFOS) but also the secondary component (PFBS) is completely absorbed.

According to the invention, over 99.5 or 99.9% by weight of the PFBS or PFOS present in the starting sample are removed, without a further sample pretreatment being required.

In addition, the chromic acid present in the wastewater surprisingly does not adversely affect the result.

### Example 5

The rinsing water having a pH of about 1.5 from decorative chromium plating, which still contained an average of 0.75 g/l of chromate calculated as CrO₃, was passed directly through activated carbon candle filters and subsequently through two cartridges which were filled with Lewatit®MP62 and had a resin volume of 50 l each. Samples were taken twice a week at the outlet from the ion exchanger cartridges and these were analysed for fluorinated acids. The rinsing water throughput was 120 m³ per day.

Table 2 shows the results:

TABLE 2

| | | PFBS | PFOS |
|---|---|---|---|
| Example | Sample | [μg/l] | [μg/l] |
| | Starting sample | 3 | 63 |
| 5a | Eluate after 1^{st} day | <0.3 | 0.6 |
| 5b | Eluate after 4^{th} day | <0.3 | 0.6 |
| 5c | Eluate after 7^{th} day | <0.3 | 1.5 |

The results show that the perfluorobutanesulphonic acid (PFBS) present in the wastewater was removed to an extent of more than 90% and perfluorooctanesulphonic acid (PFOS) was removed virtually quantitatively.

1. Process for separating fluorinated acids or salts thereof from their metal-containing, aqueous solutions, where metal-containing means a content of at least one transition metal compound, characterized in that abovementioned solutions are contacted with at least one weakly or strongly basic anion exchanger.

2. Process according to claim 1, characterized in that the metal-containing, aqueous solutions contain a total amount of fluorinated acids or salts of fluorinated acids of from 1 to 200 000 μg/l, preferably from 1 to 100 000 μg/l, particularly preferably from 10 to 2000 μg/l, very particularly preferably from 10 to 1000 μg/l and even more preferably from 10 to 500 μg/l.

3. Process according to claim 1 or 2, characterized in that the fluorinated acids are the following:
Polyfluorocarboxylic and perfluorocarboxylic acids of the formula (I) and
polyfluorosulphonic and perfluorosulphonic acids of the formula (II)
F—(CF₂)ₙ—(CH₂)ₘ—COOH (I)
F—(CF₂)ₙ—(CH₂)ₘ—SO₂OH (II)
where in each case
n is an integer from 3 to 10, preferably from 4 to 8, and
m is 0 or an integer from 1 to 4.

4. Process according to any of claims 1 to 3, characterized in that the metal-containing, aqueous solutions contain at least one transition metal compound, where the content of transition metal compounds calculated as the respective transition metal oxide having the same oxidation state as the at least one transition metal compound present is from 10 mg/l to 100 g/l, preferably from 50 mg/l to 10 g/l, particularly preferably from 100 mg/l to 5 g/l very particularly preferably from 250 mg/l to 5 g/l and even more preferably from 500 mg/l to 5 g/l.

5. Process according to any of claims 1 to 4, characterized in that the metal-containing, aqueous solutions are chromium-containing and have a chromium content of from 10 mg/l to 100 g/l, preferably from 50 mg/l to 10 g/l, particularly preferably from 100 mg/l to 5 g/l, very particularly preferably from 250 mg/l to 5 g/l and even more preferably from 500 mg/l to 5 g/l.

6. Process according to any of claims 1 to 5, characterized in that the pH of the metal-containing, aqueous solutions of fluorinated acids or salts thereof is from 0 to 7 under standard conditions.

7. Process according to any of claims 1 to 6, characterized in that the pH of the metal-containing, aqueous solutions of fluorinated acids or salts thereof is from 0.0 to 3.0, preferably from 0.0 to 2.5, under standard conditions.

8. Process according to either claim 6 or 7, characterized in that when the metal-containing, aqueous solutions have a pH of less than 7 under standard conditions, the solutions additionally contain sulphuric acid and/or hydrogensulphate.

9. Process according to any of claims 1 to 8, characterized in that the metal-containing, aqueous solutions are wastewater from electroplating plants.

10. Process according to any of claims 1 to 10, characterized in that anion exchangers having the structural element of the formula (IV) or the structural element of the formula (V) or structural elements of the formulae (IV) and (V)
—N⁺(R⁴R⁵R⁶)X⁻ (IV)
where
R⁴, R⁵ and R⁶ are each, independently of one another, hydrogen or C₁-C₁₂-alkyl which may be either unsubstituted or further monosubstituted or polysubstituted by hydroxy or C₁-C₄-alkoxy, or, if two of the radicals R⁴, R⁵ and R⁶ are not hydrogen, these radicals together form C₂-C₁₂-alkylene which may be unsubstituted, monosubstituted or polysubstituted by hydroxy or C₁-C₄-alkoxy, but at least one of the radicals R⁴, R⁵ and R⁶ is hydrogen, and
X⁻ is an anion,
−N(R⁷R⁸) (V)
where
R⁷ and R⁸ are each, independently of one another, hydrogen or C₁-C₁₂-alkyl which may either be unsubstituted or further monosubstituted or polysubstituted by hydroxy or C₁-C₄-alkoxy, or, if two of the radicals R⁷ and R⁵ are not hydrogen, these radicals together form C₂-C₁₂-alkylene which may be unsubstituted, monosubstituted or polysubstituted by hydroxy or C₁-C₄-alkoxy,
are used as anion exchangers.

11. Process according to any of claims 1 to 10, characterized in that the contacting of the metal-containing, aqueous solutions is carried out at a flow rate of from 0.5 to 200 parts by volume of metal-containing, aqueous solution per hour and part by volume of anion exchanger.

12. Process according to any of claims 1 to 11, characterized in that the metal-containing, aqueous solutions are brought into contact with adsorbents in order to remove possible residues of fluorinated acids or salts thereof after contacting with the anion exchanger.

13. Process according to any of claims 1 to 12, characterized in that the metal-containing, aqueous solutions are brought into contact with adsorbents in order to remove proportions of fluorinated acids or salts thereof before contacting with the anion exchanger.

14. Process according to any of claims 1 to 13, characterized in that the anion exchangers loaded with fluorinated acids after carrying out the process are incinerated at temperatures above 1100° C.

15. Use of anion exchangers in a process according to any of claims 1 to 14.
